(19) United States
(12) Patent Application Publication
(10) Pub. No.: US 2018/0279089 A1
(43) Pub. Date: Sep. 27, 2018

(54) COMPONENT SPECIFICATION NOTIFICATION SYSTEM, METHOD, AND DEVICE

(71) Applicants: HYUNDAI MOTOR COMPANY, Seoul (KR); KIA MOTORS CORPORATION, Seoul (KR)

(72) Inventors: Sung Wook Lee, Seoul (KR); Hyeoung Kim, Suwon-si (KR); Deug Young So, Suwon-si (KR)

(73) Assignees: HYUNDAI MOTOR COMPANY, Seoul (KR); KIA MOTORS CORPORATION, Seoul (KR)

(21) Appl. No.: 15/710,448

(22) Filed: Sep. 20, 2017

(30) Foreign Application Priority Data
Mar. 27, 2017 (KR) 10-2017-0038731

(51) Int. Cl. H04W 4/04

(52) U.S. Cl. CPC H04W 4/046

(57) ABSTRACT

A component specification notification system includes a smart tag attached to an assembled vehicle body and a specification notification device configured to receive information on the assembled vehicle body from the smart tag and to select and notify components to be fastened to the assembled vehicle body.

### CROSS-REFERENCE TO RELATED APPLICATION

This application claims priority to and the benefit of Korean Patent Application No. 10-2017-0038731 filed in the Korean Intellectual Property Office on Mar. 27, 2017, the entire contents of which are incorporated herein by reference.

### BACKGROUND

### (a) Field of the Disclosure

The present disclosure relates to a component specification notification system, a component specification notification method, and a component specification notification device. The disclosed system, method, and device enable rapid and accurate recognition of a specification of an assembled vehicle body and perform a fastening work suitable for the recognized assembled vehicle body.

### (b) Description of the Related Art

Typically, in the process of producing a finished vehicle, most of the work is a fastening process in which bolts and nuts are fastened to an assembled vehicle body or used to assemble the vehicle body.

This assembling process is directly related to durability or quietness of the vehicle a consumer perceives. Thus, the assembling process needs to be thoroughly managed.

A barcode or a passive radio frequency identification (RFID) tag is used to systematically manage the assembling process. However, since the barcode or the passive RFID tag has low position detection accuracy, it is not easy to manage a history of the assembling process. As a result, the assembling process cannot be effectively managed.

A conventional method in which a worker interprets part specification information of a work instruction sheet and fastens a part to a vehicle is used. In the conventional art, a fastening error may occur, assembly productivity may vary depending on the worker, and a production efficiency of the vehicle may be lowered.

The above information disclosed in this Background section is provided to enhance understanding of the background of the disclosure. Therefore, the Background section may contain information that does not form the prior art that is already known in this country to a person of ordinary skill in the art.

### SUMMARY

The present disclosure relates to a component specification notification system, a component specification notification method, and a component specification notification device. The disclosed system, method, and device are capable of improving productivity and reducing fastening errors by recognizing a specification of an assembled vehicle body more quickly and accurately and informing components that fit the recognized assembled vehicle body.

An embodiment of the present disclosure may provide the component specification notification system. The system may include a smart tag attached to an assembled vehicle body and a specification notification device configured to receive information on or about the assembled vehicle body from the smart tag and to select and notify components to be fastened to the assembled vehicle body.

The specification notification device may include: a component loader including compartments in which the components are disposed; a notification part disposed in each of the compartments; and a notification controller configured to control operation of the notification part.

The notification part may inform of or identify a position of the compartment where the component to be fastened is disposed using a light emitting source.

The light emitting source may be a light emitting diode (LED) light source.

The notification controller may include: a wireless transceiver configured to wirelessly transmit and receive the information with the smart tag; a memory in which the information is stored and updated; a controller configured to calculate the information transmitted and received and to control operations of the notification part, the wireless transceiver, and the memory; and a power supply configured to apply power to the notification part, the wireless transceiver, the memory, and the controller.

The smart tag may include: a wireless transceiver configured to perform wireless communication with the specification notification device; a memory in which data transmitted and received from and to the wireless transceiver is stored; a controller configured to calculate the data and control operations of the wireless transceiver and the memory; and a power supply configured to supply power to the wireless transceiver, the memory, and the controller.

Specification of the assembled vehicle body or the components, the assembled vehicle body number, an inspection result of the assembled vehicle body, a repair history of the assembled vehicle body, or quality history information on the assembled vehicle body may be stored and updated in the memory.

An embodiment of the present disclosure may provide the component specification notification method. The method may include: exchanging information wirelessly with a smart tag attached to an assembly vehicle body; determining specification of the assembled vehicle body and specification of a component to be fastened using the exchanged information; and operating a notification part corresponding to a compartment in which the component to be fastened to the assembly vehicle body is loaded.

The notification part may inform of or identify a position of the compartment where the component to be fastened is disposed using a light emitting source.

The exchanging of the information may include transmitting and receiving the information to and from the smart tag using a wireless transceiver. The information may be stored in a memory.

The smart tag may transmit and receive the information using a wireless transceiver.

Specification of the assembled vehicle body or the component, the assembled vehicle body number, an inspection result of the assembled vehicle body, or quality history information on the assembled vehicle body may be stored and updated in a memory of the smart tag. Any one or more of the specification, the body number, the inspection result, and the quality history may be stored and updated in the memory of the smart tag.

An embodiment of the present disclosure may provide the component specification notification device. The device may be configured to receive information on an assembled vehicle body and to select and notify components to be fastened to the assembled vehicle body. The device may include: a component loader including compartments in which the components are disposed; a notification part disposed in each of the compartments; and a notification controller configured to control operation of the notification part.

The notification part may inform of or identify a position of the compartment where the component to be fastened is disposed using a light emitting source.

The notification controller may include: a wireless transceiver configured to wirelessly transmit and receive the information; a memory in which the information is stored and updated; a controller configured to calculate the information transmitted and received and to control operations of the notification part, the wireless transceiver, and the memory; and a power supply configured to apply power to the notification part, the wireless transceiver, the memory, and the controller.

The disclosed embodiment may prevent work errors and may improve productivity and assembling quality of the vehicle by wirelessly receiving specification information of a component to be fastened from a smart tag to light a lamp (e.g., a light emitting diode (LED) lamp) corresponding to the component.

Further, the disclosed embodiment may be applied to a process of assembling small components and large components using a compartment of the component specification notification device.

### BRIEF DESCRIPTION OF THE DRAWINGS

FIG. 1 is a schematic configuration diagram showing a component specification notification system according to an embodiment of the present disclosure.

FIG. 2 is a schematic diagram of a component specification notification device according to an embodiment of the present disclosure.

FIG. 3 is a flowchart showing a component specification notification method according to an embodiment of the present disclosure.

FIG. 4 is a table showing information stored in a smart tag and the component specification notification device according to an embodiment of the present disclosure.

FIG. 5 is a schematic configuration diagram of the smart tag according to an embodiment of the present disclosure.

### DETAILED DESCRIPTION OF THE EMBODIMENTS

An embodiment of the present disclosure is hereinafter described in detail with reference to the accompanying drawings.

The sizes and thicknesses of the configurations shown in the drawings are provided selectively for the convenience of description. The present disclosure is not limited to those shown in the drawings and the thicknesses are exaggerated to make some parts and regions clear.

However, parts which are not related with or necessary for the description are omitted to more clearly describe an embodiment of the present disclosure. Like reference numerals refer to like or similar elements throughout the specification. The following reference numerals relate to the noted elements in the drawings.

100: assembled vehicle body 110: smart tag

120: specification notification device 125: notification controller

130: component loader 132: compartments

134: notification part 200, 330: wireless transceiver

220, 300: controller 210, 310: power supply

230, 340: memory 320: generator 350: position sensor 360: state display device

In the following description, dividing names of components into first, second, and the like is to differentiate the names because the names of the components are otherwise the same as each other. An order of such components is not intended by the use of such names.

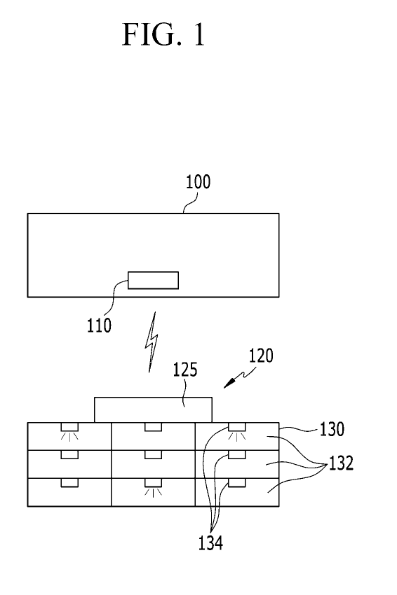

FIG. 1 is a schematic configuration diagram showing a component specification notification system according to an embodiment of the present disclosure.

Referring to FIG. 1, the component specification notification system may include an assembled vehicle body 100, a smart tag 110, and a component specification notification device 120. The specification notification device 120 may include a notification controller 125, a component loader 130, compartments 132, and a notification part 134.

The smart tag 110 may be attached to the assembled vehicle body 100 and may transmit and receive information to and from the notification controller 125. When the smart tag 110 transmits a specification of a component to be mounted to the assembled vehicle body 100 to the notification controller 125, the notification controller may operate the notification part 134 corresponding to the specification of the component to be mounted.

The specification notification device 120 may include the component loader 130 in which the compartments 132 are formed. Each of the compartments 132 may contain components necessary for a process for assembling a vehicle body. The notification part 134 may be disposed in each of the compartments 132. The notification part 134 may include a light emitting diode (LED) light source.

In the disclosed embodiment, the notification controller 125 and the smart tag 110 may exchange information with each other by themselves. Thus, the disclosed embodiment may eliminate a need for a separate server. A component (e.g., a part) suitable for a predetermined process for assembling the vehicle body may be promptly and accurately fastened.

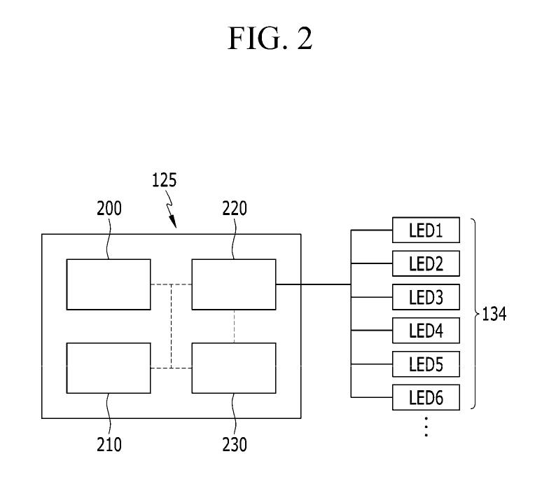

FIG. 2 is a schematic diagram of the component specification notification device according to an embodiment of the present disclosure.

Referring to FIG. 2, the notification controller 125 may include a wireless transceiver 200, a power supply (or a power supply device) 210, a memory 230, and a controller 220.

The wireless transceiver 200 may wirelessly transmit and receive information to and from the smart tag 110. The information may include the process information, specification information of the assembled vehicle body, and specification information on the component to be assembled in the process.

The power supply 210 may supply power to the wireless transceiver 200, the memory 230, and the controller 220. The process information, the assembled vehicle body information, and the component information for components to be fastened to the assembled vehicle body 100 corresponding to the process are stored and updated in the memory 230.

The notification part 134 may include the LED as a light emitting device. The LED may be disposed corresponding to each component. The notification controller 125 may receive the assembled vehicle body information, the process information, and the component information from the smart tag 110 through the wireless transceiver 200. The notification controller 125 may control supplying power to the LED disposed in the compartment 132 in which a component to be fastened is loaded in order to operate the notification part 134 based on the component information to be fastened.

For example, the controller 220 may be one or more microprocessors operated by a program or hardware including the microprocessor. The program may include a series of commands for executing the method according to the disclosed embodiment, which is described below.

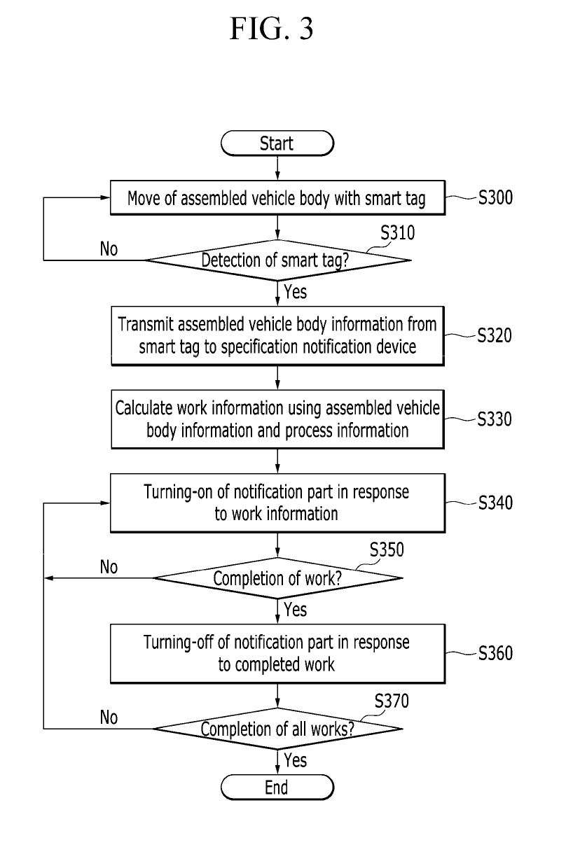

FIG. 3 is a flowchart showing a component specification notification method according to an embodiment of the present disclosure.

Referring to FIG. 3, in a step S300, the assembled vehicle body 100 to which the smart tag 110 is attached may be moved. The assembled vehicle body 100 may be transported by a conveyor, and a worker (or an operator) may move the assembled vehicle body 100 to a work space using the conveyor.

In a step S310, the wireless transceiver 200 may transmit and receive information to and from the smart tag 110 to detect the smart tag. In a step S320, the specification notification device 120 may receive the assembled vehicle body information, the specification information of the assembled vehicle body, and the component information from the smart tag 110. In other words, the smart tag 110 may transmit the assembled vehicle body information, the specification information of the assembled vehicle body, and the component information to the specification notification device 120.

In a step S330, the controller 220 may calculate or get work information using the transmitted and received information and may select the component to be fastened based on the work information. In a step S340, the controller 220 may operate the notification part 134 informing the component to be fastened in response to the work information.

In a step S350, it may be determined whether the work is completed. That is, it may be determined whether the component to be fastened in the process is fastened. When it is determined that the component is fastened, a step S360 may be performed. When it is determined that the component is not fastened, the step S340 may be performed.

Completion of the work may be determined by a server using information transmitted and received between a tool used in the work and the server. Completion of the work may be determined by the specification notification device 120 (or the controller 220) using information transmitted and received between the tool used in the work and the specification notification device. Completion of the work for fastening the component may be determined by the worker.

In a step S360, the notification part 134 corresponding to the fastened component may be turned off in response to the completed work. In a step S370, it may be determined whether all procedures or works for fastening the component are completed. When it is determined that all works are completed, the method may be terminated. When it is determined that all works are not completed, the step S340 may be performed.

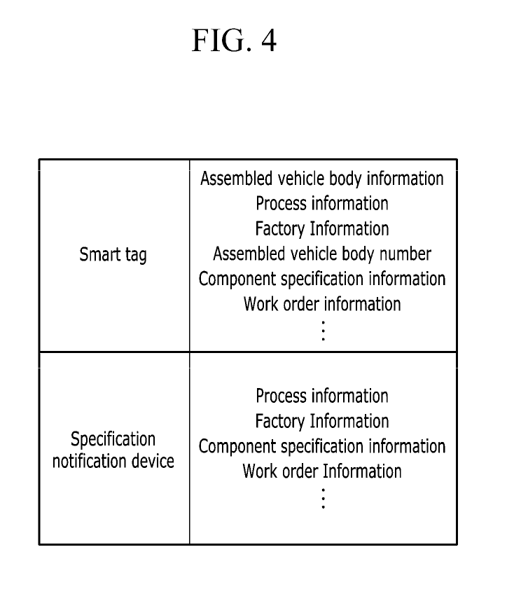

FIG. 4 is a table showing information stored in the smart tag and the component specification notification device according to an embodiment of the present disclosure.

Referring to FIG. 4, the assembled vehicle body information, the process information, factory information, an assembled vehicle body number, component specification information, and work order information may be stored and updated in a memory of the smart tag 110. The process information, the factory information, the component specification information, and the work order information may be stored and updated in a memory of the specification notification device 120.

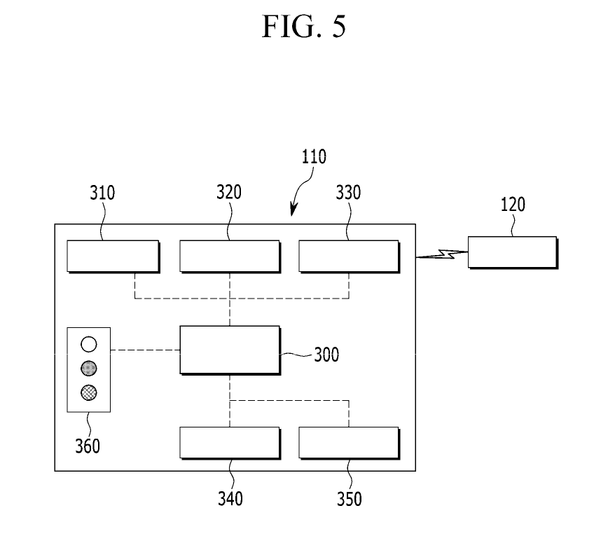

FIG. 5 is a schematic configuration diagram of the smart tag according to an embodiment of the present disclosure.

Referring to FIG. 5, the smart tag 110 may include a power supply 310, a generator 320 generating a signal for position measurement, a wireless transceiver 330, a controller 300, a state display device 360, a memory 340, and a position sensor 350. The wireless transceiver 330 may transmit and receive information to and from the specification notification device 120.

The power supply 310 may supply power to the generator 320, the wireless transceiver 330, the controller 300, the state display device 360, the memory 340, and the position sensor 350. The generator 320 may output a signal externally for position measurement. The output signal can be such that an external sensor detects a position of the smart tag 110.

The wireless transceiver 330 may transmit data and may receive data. The memory 340 may store and update the data. The position sensor 350 may sense a position of the smart tag 110. The state display device 360 may display a state using a light source such as the LED. The controller may control the power supply 310, the generator 320, the wireless transceiver 330, the controller 300, the state display device 360, the memory 340, and the position sensor 350.

While this disclosure has been described in connection with what is presently considered to be practical embodiments, it is to be understood that the disclosure is not limited to the disclosed embodiments. On the contrary, this disclosure is intended to cover various modifications and equivalent arrangements included within the spirit and scope of the appended claims.

What is claimed is:

1. A component specification notification system comprising:
a smart tag attached to an assembled vehicle body; and
a specification notification device configured to receive information on the assembled vehicle body from the smart tag and to select and notify components to be fastened to the assembled vehicle body.

2. The component specification notification system of claim 1, wherein the specification notification device comprises:
a component loader including compartments in which the components are disposed;
a notification part disposed in each of the compartments; and
a notification controller configured to control operation of the notification part.

3. The component specification notification system of claim 2, wherein the notification part informs position of the compartment where the component to be fastened is disposed using a light emitting source.

4. The component specification notification system of claim 3, wherein the light emitting source is a light emitting diode (LED) light source.

5. The component specification notification system of claim 2, wherein the notification controller comprises:
a wireless transceiver configured to wirelessly transmit and receive the information with the smart tag;
a memory in which the information is stored and updated;
a controller configured to calculate the information transmitted and received and to control operations of the notification part, the wireless transceiver, and the memory; and
a power supply configured to apply power to the notification part, the wireless transceiver, the memory, and the controller.

6. The component specification notification system of claim 1, wherein the smart tag comprises:
a wireless transceiver configured to perform wireless communication with the specification notification device;
a memory in which data transmitted and received from and to the wireless transceiver is stored;
a controller configured to calculate the data and to control operations of the wireless transceiver and the memory; and
a power supply configured to supply power to the wireless transceiver, the memory, and the controller.

7. The component specification notification system of claim 6, wherein specification of the assembled vehicle body or the components, the assembled vehicle body number, an inspection result of the assembled vehicle body, or quality history information on the assembled vehicle body is stored and updated in the memory.

8. A component specification notification method comprising:
exchanging information wirelessly with a smart tag attached to an assembly vehicle body;
determining specification of the assembled vehicle body and specification of a component to be fastened using the exchanged information; and
operating a notification part corresponding to a compartment in which the component to be fastened to the assembly vehicle body is loaded.

9. The component specification notification method of claim 8, wherein the notification part informs position of the compartment where the component to be fastened is disposed using a light emitting source.

10. The component specification notification method of claim 8, wherein the exchanging of the information includes transmitting and receiving the information to and from the smart tag using a wireless transceiver and the information is stored in a memory.

11. The component specification notification method of claim 8, wherein the smart tag transmits and receives the information using a wireless transceiver.

12. The component specification notification method of claim 11, wherein specification of the assembled vehicle body or the component, the assembled vehicle body number, an inspection result of the assembled vehicle body, and/or quality history information on the assembled vehicle body is stored and updated in a memory of the smart tag.

13. A component specification notification device configured to receive information on an assembled vehicle body and to select and notify components to be fastened to the assembled vehicle body, the device comprising:
a component loader including compartments in which the components are disposed;
a notification part disposed in each of the compartments; and
a notification controller configured to control operation of the notification part.

14. The device of claim 13, wherein the notification part informs position of the compartment where the component to be fastened is disposed using a light emitting source.

15. The device of claim 13, wherein the notification controller comprises:
a wireless transceiver configured to wirelessly transmit and receive the information;
a memory in which the information is stored and updated;
a controller configured to calculate the information transmitted and received and to control operations of the notification part, the wireless transceiver, and the memory; and
a power supply configured to apply power to the notification part, the wireless transceiver, the memory, and the controller.
